(19) United States
(12) Patent Application Publication
(10) Pub. No.: US 2025/0307261 A1
(43) Pub. Date: Oct. 2, 2025

(54) METHOD AND SYSTEM FOR ATTRIBUTE COMMUNITY SEARCH BASED ON RELATION TREE

(71) Applicant: Hangzhou Dianzi University, HANGZHOU CITY (CN)

(72) Inventors: Yuxiang WANG, HANGZHOU CITY (CN); Kalle LIU, HANGZHOU CITY (CN); Xiaoliang XU, HANGZHOU CITY (CN); Yuxiang WANG, HANGZHOU CITY (CN); Bin CHEN, HANGZHOU CITY (CN)

(21) Appl. No.: 19/013,824

(22) Filed: Jan. 8, 2025

(30) Foreign Application Priority Data
Apr. 2, 2024 (CN) 202410393127.8

(51) Int. Cl. G06F 16/248; G06F 16/22; G06F 16/28

(52) U.S. Cl. CPC G06F 16/248; G06F 16/2246; G06F 16/288

(57) ABSTRACT

A method and system for attribute community search based on a relation tree are provided. In the method, a data relation of a target domain is obtained, and an attribute information network of the target domain is constructed in the form of a graph. The attribute information network is loaded over a unified access interface, and data processing, subgraph construction, and algorithm operation and maintenance search are performed on the attribute information network. A community structure parameter k value and a search node q are received through an interface for attribute community search provided for a user, and a community that contains the search node q and satisfies structural cohesion and optimal attribute cohesion is returned. Rendering and interaction are performed on a user interface, which renders the community search result returned into a dynamic community network diagram and presents the dynamic community network diagram to the user.

### CROSS-REFERENCE TO RELATED APPLICATION

This application claims priority to Chinese Patent Application No. 2024103931278, filed on Apr. 2, 2024, which is hereby incorporated by reference in its entirety.

### TECHNICAL FIELD

The present disclosure belongs to the field of information retrieval, relates to attribute community search, and specifically relates to a method and system for attribute community search based on a relation tree.

### BACKGROUND

In recent years, the rapid development of emerging technologies such as the Internet, big data, and cloud computing has not only driven a sharp increase in the volume of data, but also made the form and content of data more complex. As a common form of data organization, a graph is often used to characterize entities in information networks and complex relations between entities, where the entities are represented as nodes in the graph and the relations are represented as edges between the nodes. Traditional information networks often only focus on relations between nodes, while ignoring rich attribute information carried by the nodes themselves, which greatly limits the ability and depth of network analysis. In such a context, attribute information networks emerge. The attribute information networks not only take relations between nodes into consideration, but also fully leverage and mine attribute information of the nodes, so as to more accurately describe and depict the complexity and diversity of information networks. Communities are close subgraph structures that are ubiquitous in information networks, reflecting strong dependencies between nodes in the information networks based on universal interaction mechanisms. How to effectively mine target communities that meet user needs from information networks is a key research issue in the field of graph data mining.

In an attribute information network, a community search refers to a process of identifying, given a search node, a community structure in the network according to attributes of nodes and connection patterns between the nodes, with attributes of the search node as an attribute input by default. This type of search utilizes attribute data to enhance community discovery to find node groups that are not only close in network connections but also similar or relevant in attribute characteristics. The community search is particularly suitable for network graphs where nodes have descriptive metadata in addition to being connected by edges. In short, the goal of the community search is to discover node sets that are cohesive both in attributes and structures.

For networks with complex attribute relations, communities are currently constrained mainly through two dimensions: structural cohesion and attribute cohesion. The structural cohesiveness is mainly constrained by classic k-core and k-truss structures to form a relatively compact subgraph community. Currently, attribute cohesiveness is mainly described using a maximum number of shared attributes, and subcommunities with the most common attributes that meet the structural cohesiveness are selected to reveal a degree of common characteristics between nodes. The above method calculates a maximum number of shared attributes based on equal value matching of attributes, ignoring the correlation of the attributes themselves, resulting in the problem of insufficient community attribute cohesiveness. In extreme cases, if it is assumed that the attributes of the search node are related to but not identical to the attributes of all nodes in the information network, an empty community will be returned; if it is assumed that the attributes of the search node are included in all the nodes in the entire network, a target community only needs to meet the structural cohesiveness, which will cause the target community to be overly large. In summary, the existing methods for attribute information network community search do not take into consideration meaning relations between attributes in results, resulting in low cohesion of community attributes in output results. Thus, a method for attribute information network community search that takes into consideration association of attribute meanings is desired.

### SUMMARY

In view of the shortcomings of the current technologies, the present disclosure proposes a method and system for attribute community search based on a relation tree, which improve the original methods by constructing a relation tree to describe inclusion relations between attributes and defining attribute scores to describe attribute cohesion and subgraph attribute cohesion between nodes. Moreover, this method for attribute information network community search further ensures uniqueness of a search result community and optimal attribute cohesion, and has a significant improvement in the cohesion of the result community compared to the existing methods.

A method for attribute community search based on a relation tree includes following steps.

Step S1, obtaining a data relation of a target domain and constructing an attribute information network of the target domain in a form of a graph; where a node of the attribute information network represent an entity in the target domain, and an edge between any two nodes represent a relation between two corresponding entities; and constructing a mapping relation between the nodes and an attribute list of the attribute information network, where each entity node corresponds to a series of attributes, indicating that the entity node has the attribute list; and constructing a relation tree on the basis of an actual attribute relation according to all attributes of the target domain;

Step S2, loading the attribute information network through a unified access interface, and performing data processing, original graph construction, subgraph construction, and algorithm operation and maintenance search on the attribute information network. An algorithm flow includes performing core decomposition on the attribute information network G, including: obtaining a subgraph H′ with the largest k-core according to a user-given value k, and then obtaining attribute scores of all nodes of the subgraph H′ other than the search node q according to the relation tree and a score calculation formula; and deleting a node with the lowest score, in which case the numbers of nodes and edges in the subgraph are n and m; if m−n<2*(k\hat{ }2−k)−1, which indicates that the subgraph does not contain the k-core, exiting the algorithm flow after adding the node with the lowest score; otherwise, repeating to perform core decomposition and delete a node with the lowest score. The algorithm flow includes following steps:

Step S2-1, performing core decomposition on the attribute information network (to obtain a subgraph H′ with the largest k-core, where the k-core indicates a community where all nodes have degrees greater than or equal to k, which includes: calculating a degree of each node (i.e., the number of edges connected to each node) in the attribute information network; and then removing all nodes in the attribute information network with degrees less than a predetermined threshold k and edges connected thereto. This operation may cause the degree of some remaining nodes to drop below k, and these nodes will also be subsequently removed. This elimination process is iteratively performed until there is no more nodes with a degree less than k. After the iteration ends, the remaining network structure is the subgraph H′ with the largest k-core, in which the degrees of all remaining nodes are at least k, thus forming a closely connected community structure where each node is connected to at least k other nodes.

Step S2-2, calculating scores of all the nodes in the subgraph according to the attribute relation. First, the relation tree T needs to be defined. The relation tree T defines an inclusion relation between attributes, where a meaning of a parent node attribute includes a meaning of a child node attribute. Through this relation tree T, a distance index between attributes may be pre-constructed, that is, a distance between any two attributes on the relation tree is calculated. A score between a node and the search node may be calculated through the score definition and the score is marked as a score of the node, and scores of all nodes in all subgraphs are calculated repeatedly. The step S2-2 include following steps.

Step S2-2-1, defining the relation tree and pre-constructing the distance index between attributes; traversing each attribute w and using a breadth-first search algorithm to mark an attribute reached at each hop until all attributes of the relation tree are traversed; for an attribute w′ reached at the h^{th} hop, storing an index <w, w′> as a distance h; and obtaining an attribute distance index after processing all the attributes of the relation tree in sequence.

Step S2-2-2, after obtaining the attribute distance index, traversing nodes of the entire subgraph except the search node for calculating a score of a target node, where n1 is the number of attributes of the search node, a₁, a₂, . . . , aₙ₁ are attributes of the search node, A is an attribute sequence of the search node, n2 is the number of attributes of the target node, b₁, b₂, . . . , bₙ₂ are attributes of the target node, and B is an attribute sequence of the target node; mindistance (aᵢ, B) is a minimum value among distances between an attribute a; and all the attributes of the sequence B, and mindistance (bⱼ, A) is a minimum value among distances between an attribute b; and all the attributes of the sequence A. The score of the target node may be obtained according to the following formula. It is easy to know that the score is normalized, and the larger the value of the score, the higher an attribute correlation between two nodes.

The score is calculated as follow:

$$Score = ( {\sum }_{i = 1}^{n 1} 0. {9}^{mindistance ( {a}_{i} , B )} + {\sum }_{j = 1}^{n 2} 0 . {9}^{mindistance ( {b}_{j} , A )} ) / ( n 1 + n 2 ) )$$

Step S2-3, after obtaining the scores of all the nodes, marking a node with the lowest score at current time, and deleting the node, in which case the numbers of nodes and edges in the subgraph are n and m; if m−n<2*(k\hat{ }2−k)−1, which indicates that the subgraph does not contain the k-core, exiting the process of the method for attribute community search after adding the node with the lowest score; otherwise, repeating to perform core decomposition and delete a node with the lowest score until the subgraph no longer contains the k-core, in which case a community is returned as a search result.

Step S3, receiving a community structure parameter k value and a search node q by providing a user with an interface for attribute community search, and returning a community that contains the search node q and satisfies structural cohesion and optimal attribute cohesion.

Step S4, rendering and interaction of a user interface, including rendering the search result returned by the interface into a dynamic community network diagram in a graphical manner, and presenting the dynamic community network diagram to the user.

A system for attribute community search based on a relation tree includes a data module, an algorithm module, an application module, and a display module.

The data module is configured for obtaining an original data relation of a target domain, constructing an attribute information network and a relation tree, and obtaining an attribute list mapping relation of nodes of the attribute information network.

The algorithm module is configured for applying the relation tree and an attribute score definition, and continuously deleting nodes with the lowest scores in a subgraph until the subgraph no longer contains a k-core, to obtain a queried community.

The application module is configured for receiving a community structure parameter k value and a search node q through a search interface provided for a user, and returning, through the algorithm module, a community that contains the search node q and satisfies structural cohesion and optimal attribute cohesion.

The display module is configured for rendering the search result into a dynamic community network diagram and displaying the dynamic community network diagram.

The present disclosure has the following beneficial effects:

The present disclosure introduces the concept of relation tree on the basis of traditional attribute community search, so that the relation between attributes is not an either-or relation, but vividly describes the complex inclusion relation between the attributes. The relation between the attributes is quantitatively described by the distance between the attributes in the relation tree, which fully takes actual situations into considerations and meets demands of users for better solutions. Additionally, the present disclosure further introduces the concept of attribute score. Compared with a traditional maximum number of common attributes, the present disclosure provides a good description of common attributes between nodes. The normalization of attribute scores also enables the attribute correlation between two nodes to be well explainable, that is, the closer the value is to 1, the higher the attribute correlation between the two nodes. Furthermore, compared with the traditional attribute information network search which needs to specify a search attribute, the present disclosure does not need to provide a search attribute list, thus reducing user input and enabling community search results more realistic.

### BRIEF DESCRIPTION OF THE DRAWINGS

FIG. 1 is a flowchart of an algorithm of attribute community search based on a relation tree according to an embodiment;

FIG. 2 is an overall architecture diagram of a method for attribute community search based on a relation tree according to an embodiment;

FIG. 3 is a schematic diagram of an attribute isomorphic network according to an embodiment;

FIG. 4 is a schematic diagram of a relation tree constructed according to an attribute relation according to an embodiment;

FIG. 5 is a schematic diagram of an initial subgraph obtained through core decomposition according to an embodiment; and

FIG. 6 is a schematic diagram of a subgraph after deleting a node with a low attribute score according to an embodiment.

### DETAILED DESCRIPTION OF THE EMBODIMENTS

Specific embodiments of the present disclosure will be described below in conjunction with the accompanying drawings.

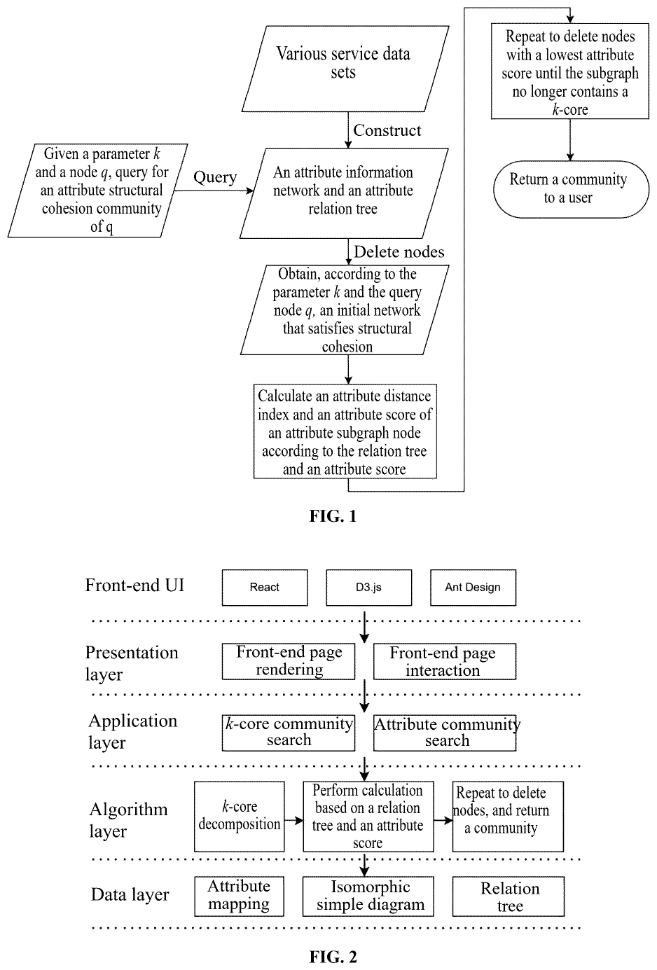

An embodiment provides a method for attribute community search based on a relation tree. An overall architecture of community search is as shown in FIG. 1 and FIG. 2, and specifically includes the following steps:

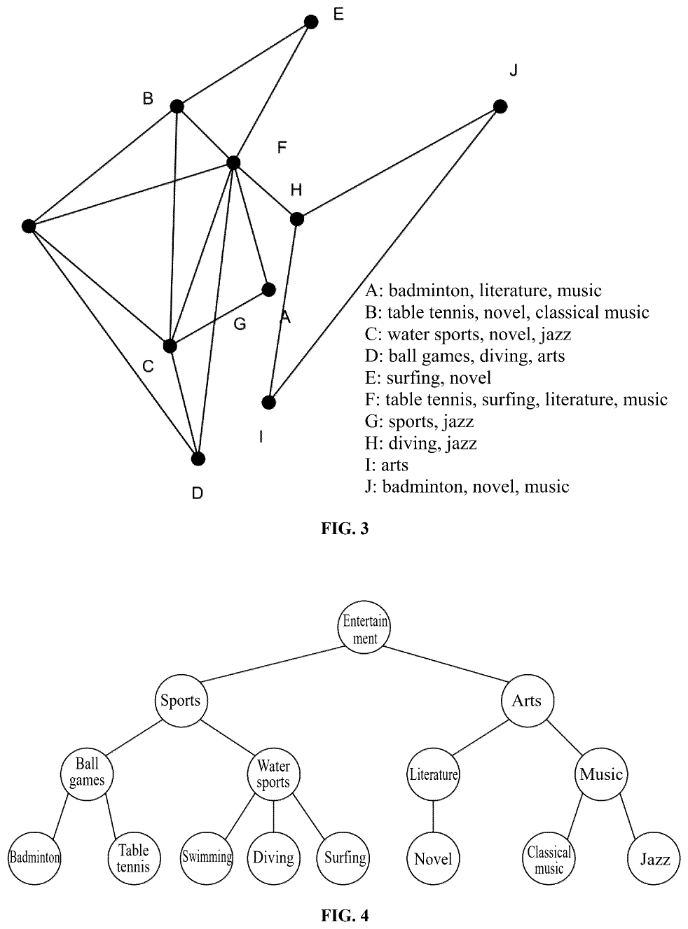

Step S1, network relation data of a target domain are obtained and an isomorphic network of the target domain is constructed, as shown in FIG. 3. Nodes in the network represent entities in the target domain, each entity corresponds to an attribute list that represents attributes of the entity, and an edge between any two nodes represents a certain confirmation relation between two corresponding entities. Furthermore, a relation tree is constructed based on an actual attribute inclusion relation according to all attributes of the target domain. In this embodiment, the network includes nodes representing users in a social network, and edges between the nodes represent associations between the users, such as friend relations. A node ball games in the network includes a series of attributes a₁a₂ . . . a₅, which respectively represents that a user ball games in the social network has a₁a₂ . . . a₅ and other hobbies, such as badminton, swimming, calligraphy, etc. For the relation tree, each node represents a type of attribute, all nodes in the entire relation tree cover all attributes of the tree, and attributes of a parent node include attributes of a child node. For example, ball games include badminton, table tennis, basketball, etc. A distance between two attributes on the relation tree also reflects a similarity between the attributes.

Step S2, the above attribute network is loaded over a unified access interface, and data processing, subgraph construction, and algorithm operation and maintenance search are performed on the attribute network. In this embodiment, a k-core is constrained to k=3, and a search node is “ball games”. An algorithm flow is shown in FIG. 1. First, core decomposition is performed on an initial graph, and a subgraph as shown in FIG. 5 is obtained using a given algorithm. The degrees of all nodes in the subgraph are greater than or equal to 3. Then, an attribute distance index is constructed according to the relation tree constructed in the data layer. A breadth-first search algorithm is used to obtain a distance of each attribute pair and the attribute pair and the distance are stored as a relation mapping therebetween. If the relation tree does not change, the attribute distance index mapping will not change either. For nodes other than the search node “ball games” in FIG. 5, attribute scores are calculated. A distance between attribute pairs is obtained from the attribute distance index, and a score of the target node is obtained by bidirectional calculation according to an attribute score formula. And then, a node with the smallest attribute score is deleted, and it is determined whether the current subgraph contains the k-core according to the numbers of nodes and edges after the node is deleted. If the current subgraph does not contain the k-core, the deleted node is added and the process ends directly. Otherwise, the core decomposition is performed to obtain a new subgraph and nodes with the smallest attribute score are repeatedly deleted. Specific steps include:

Step S2-1, core decomposition is performed on the initial graph and nodes with a degree less than 3 are iteratively deleted. Firstly, nodes E, J, I, and G are deleted, and adjacent edges of these nodes are also deleted. Then, since the degree of node H is less than 3, node H is deleted, and an initial subgraph H′ with the greatest k-core shown in FIG. 5 is obtained, where the subgraph H′ with k-core represents a community where the degrees of all nodes are greater than or equal to k.

Step S2-2, the attribute distance index is constructed based on the relation tree constructed in the data layer. A parent-child relation of nodes in the relation tree has practical meaning. According to FIG. 4, a parent node “entertainment” contains “sports” and “arts”, that is, “sports” and “arts” belong to the “entertainment” category. Attribute scores of nodes other than the search node in the attribute information network are solved according to the attribute distance index and an attribute score definition. The attribute score definition is of a bidirectional asymmetric structure and needs to be calculated from two dimensions: the search node and the target node. A final attribute score value is normalized and represents an attribute correlation between the target node and the search node. The smallest attribute score represents an overall correlation of the subgraph. Then, nodes with the lowest scores are iteratively deleted to maintain the overall subgraph with an increasingly larger lowest score, which indicates a higher subgraph attribute relevance. Specific steps include:

Step S2-2-1, the attribute distance index is constructed according to the relation tree, that is, distances of all attribute pairs are resolved. For an attribute “badminton”, a breadth-first search (BFS) algorithm is used. The first hop is “ball games”, and therefore a distance of attribute pair <badminton, ball games> is 1; the second hop is “sports” and “table tennis”, and therefore distances of attribute pairs <badminton, sports> and <badminton, table tennis> are stored as 2, which is repeated in a same manner until all the attribute nodes of the relation tree are traversed. The above process is then repeated using a BFS algorithm starting from “table tennis”, which is repeated in a same manner to solve all the attribute pairs. The attribute distance index mapping is obtained according to the above attribute pairs. If the relation tree remains unchanged, the mapping remains unchanged. During subsequent solution of a distance between attributes, only the index needs to be taken out.

Step S2-2-2, nodes except the search node “ball games” are calculated according to the attribute distance index. For a target node “water sports”, calculation is performed according to the attribute score definition. An attribute list {badminton, literature, music} of the search node is traversed. For the attribute “badminton”, an attribute list {table tennis, novel, classical music} of the target node is traversed, and <badminton, table tennis>, <badminton, novel>, and <badminton, classical music> in the attribute distance index are taken out, and a smallest distance of 2 is obtained. For the attribute “literature”, the attribute list {table tennis, novel, classical music} of the target node is traversed, and <literature, table tennis>, <literature, novel>, and <literature, classical music> in the attribute distance index are taken out, and a smallest distance of 1 is obtained. For the attribute “music”, the attribute list {table tennis, novel, classical music} of the target node is traversed, and <music, table tennis>, <music, novel>, and <music, classical music> in the attribute distance index are taken out, and a smallest distance of 1 is obtained. For the attribute list {table tennis, novel, classical music} of the target node and the attribute “table tennis”, the attribute list {badminton, literature, music} of the search node is traversed, and <table tennis, badminton>, <table tennis, literature>, and <table tennis, music> in the attribute distance index are taken out, and a smallest distance of 2 is obtained. For the attribute “novel”, the attribute list {badminton, literature, music} of the search node is traversed, and <novel, badminton>, <novel, literature>, and <novel, music> in the attribute distance index are taken out, and a smallest distance of 1 is obtained. For the attribute “classical music”, the attribute list {badminton, literature, music} of the search node is traversed, and <classical music, badminton>, <classical music, literature>, and <classical music, music> in the attribute distance index are taken out, and a smallest distance of 1 is obtained. According to the following attribute score formula, a score is calculated as 0.87. Similarly, the attribute scores of nodes C, D, and F may be calculated as 0.843, 0.859, and 0.897, respectively.

Score=(Σᵢ₌₁ⁿ¹,0.9\hat{ }mindistance(aᵢ,B)+Σⱼ₌₁ⁿ²,0.9\hat{ }mindistance(bⱼ,A))/(n1+n2))

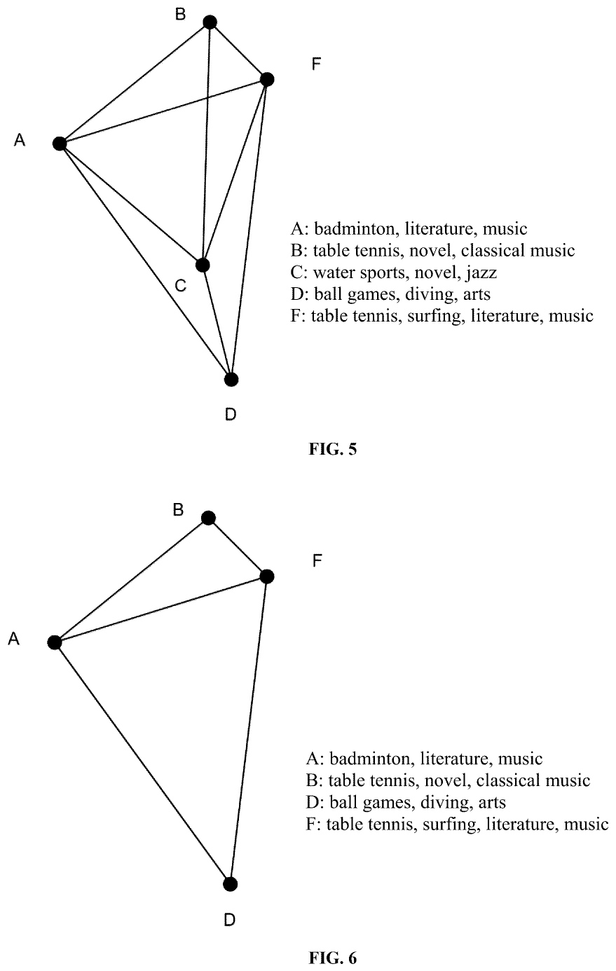

Step S2-3, after the attribute scores of all the nodes are obtained, the node “literature” with the lowest score is deleted, where after deletion, the number n of nodes is 4 and the number m of edges is 5; it is determined, according to m−n<2*(k\hat{ }2−k)−1, that the subgraph does not contain the k-core, and the node “literature” is added and then the process is exited, and a search result is returned as shown in FIG. 6.

Step S3, a community search interface is provided for a user and the above community search algorithm is called to complete the following functions: receiving a community structure parameter k value of 3 and the search node “ball games”; returning, through the algorithm layer, a community that contains the search node “ball games” and satisfies structural cohesion and optimal attribute cohesion to implement k-core community search through the algorithm layer.

Step S4, rendering and interaction are performed on a user interface, which presents the community search result returned by the interface to the user in a graphical manner and renders the search result into a dynamic community network diagram. To achieve this function, a React framework is combined with D3.js and Ant Design component libraries to visualize community network relations. The community structure parameter k value and the search target q are input in a front-end interface by the user, and a GET or POST request is sent to an application layer using an HTTP client library such as Fetch API or Axios. After receiving the request, the application layer executes corresponding search logic and returns a result to a presentation layer. After receiving the search result, the presentation layer renders the result into a dynamic community network diagram by using a component-based development concept of React combined with powerful data visualization capabilities of D3.js.

A system for attribute community search based on a relation tree includes a data module, an algorithm module, an application module, and a display module.

The data module is configured for obtaining an original data relation of a target domain, constructing an attribute information network and a relation tree, and obtaining an attribute list mapping relation of nodes of the attribute information network.

The algorithm module is configured for applying the relation tree and an attribute score definition, and continuously deleting nodes with the lowest scores in a subgraph until the subgraph no longer contains a k-core, to obtaining a queried community.

The application module is configured for receiving a community structure parameter k value and a search node q through a search interface provided for a user, and returning, through the algorithm module, a community that contains the search node q and satisfies structural cohesion and optimal attribute cohesion.

The display module is configured for rendering the search result into a dynamic community network diagram and displaying the dynamic community network diagram.

It should be emphasized that the above description is only a detailed explanation of preferred embodiments of the present disclosure and operating principles thereof. However, for those skilled in the art with ordinary knowledge in this technical field, various modifications and changes may be made according to the core concepts disclosed in the present disclosure in different specific implementation processes. These adjustments and changes based on the core principles of the present disclosure should be understood to also fall within the scope of protection claimed in the present disclosure, that is, these changes and adjustments should be regarded as part of protection of the present disclosure.

What is claimed is:

1. A method for attribute community search based on a relation tree, comprising following steps:
step S1, obtaining a data relation of a target domain and constructing an attribute information network of the target domain in a form of a graph;
step S2, loading the attribute information network over a unified access interface, performing data processing, subgraph construction, and algorithm operation and maintenance search on the attribute information network;
step S3, receiving a community structure parameter k value and a search node q through an interface for attribute community search provided for a user, and returning a community that contains the search node q and satisfies structural cohesion and optimal attribute cohesion; and
step S4, performing rendering and interaction on a user interface, rendering a community search result returned by the interface into a dynamic community network diagram in a graphical manner, and presenting the dynamic community network diagram to the user.

2. The method according to claim 1, wherein nodes of the attribute information network in the step S1 represent entities in the target domain, and an edge between any two nodes represent a relation between two corresponding entities.

3. The method according to claim 2, wherein the step S1 further comprises:
constructing a mapping relation between the nodes and attribute lists of the attribute information network, wherein each entity node corresponds to a series of attributes, indicating that the entity node has the attribute list; and constructing a relation tree on the basis of an actual attribute relation according to all attributes of the target domain.

4. The method according to claim 2, wherein the step S2 comprises:
step S2-1, performing core decomposition on the attribute information network G to obtain a subgraph H′ with a largest k-core, the k-core indicating a community where all nodes have degrees greater than or equal to k, which comprises: calculating a degree of each node in the attribute information network, that is, a number of edges connected to each node; removing all nodes in the attribute information network with degrees less than a predetermined threshold k and edges connected thereto; and repeating the removing until there are no more nodes with a degree less than k, thereby obtaining a remaining network structure as the subgraph H′ with the largest k-core;
step S2-2, calculating scores of all the nodes in the subgraph according to an attribute relation, comprising: defining a relation tree T, wherein the relation tree T defines an inclusion relation between attributes, and a meaning of a parent node attribute comprises a meaning of a child node attribute; and pre-constructing a distance index between attributes through the relation tree T, that is, calculating a distance between any two attributes on the relation tree; and calculating a score between a node and a search node through the score definition, marking the score as a score of the node, and repeatedly calculating scores of all the nodes in the subgraph; and
step S2-3, after obtaining the scores of all the nodes, marking a node with a lowest score at current time, and deleting the node, in which case numbers of nodes and edges in the subgraph are n and m; if m−n<2*(k\hat{ }2−k)−1, which indicates that the subgraph does not contain the k-core, exiting the method for attribute community search after adding the node with the lowest score; otherwise, repeating to perform core decomposition and delete a node with the lowest score until the subgraph no longer contains the k-core, in which case a community is returned as a search result.

5. The method according to claim 4, wherein the step S2-2 comprises:
step S2-2-1, defining the relation tree and pre-constructing the distance index between attributes; traversing each attribute w and using a breadth-first search algorithm to mark an attribute reached at each hop until all attributes of the relation tree are traversed; for an attribute w′ reached at h^{th} hop, storing an index <w, w′> as a distance h; and obtaining an attribute distance index after processing all the attributes of the relation tree in sequence;
step S2-2-2, after obtaining the attribute distance index, traversing nodes of an entire subgraph except the search node for calculating a score of a target node, wherein in response to increasing of the score, an attribute correlation between two nodes increases, and the score is calculated as follow:
$$Score = ( {\sum }_{i = 1}^{n 1} 0 . {9}^{mindistance ( {a}_{i} , B )} + {\sum }_{j = 1}^{n 2} 0 . {9}^{mindistance ( {b}_{j} , A )} ) / ( n 1 + n 2 ) )$$
wherein n1 is a number of attributes of the search node, a₁, a₂, . . . , aₙ₁ are attributes of the search node, A is an attribute sequence of the search node, n2 is a number of attributes of the target node, b₁, b₂, . . . , bₙ₂ are attributes of the target node, and B is an attribute sequence of the target node; mindistance (aᵢ, B) is a minimum value among distances between an attribute aᵢ and all attributes of attribute sequence B, and mindistance (bⱼ, A) is a minimum value among distances between an attribute bⱼ and all attributes of attribute sequence A.

6. A system for attribute community search based on a relation tree for implementing the method for attribute community search according to claim 1, comprising a data module, an algorithm module, an application module, and a display module;
the data module is configured for obtaining an original data relation of the target domain, constructing the attribute information network and the relation tree, and obtaining an attribute list mapping relation of nodes of the attribute information network;
the algorithm module is configured for applying the relation tree and an attribute score definition, and repeating to delete nodes with lowest scores in a subgraph until the subgraph no longer contains a k-core, to obtain a queried community;
the application module is configured for receiving a community structure parameter k value and a search node q through a search interface provided for a user, and returning, through the algorithm module, a community that contains the search node q and satisfies structural cohesion and optimal attribute cohesion;
the display module is configured for rendering the search result into a dynamic community network diagram and displaying the dynamic community network diagram.

7. The system according to claim 6, wherein nodes of the attribute information network in the step S1 represent entities in the target domain, and an edge between any two nodes represent a relation between two corresponding entities.

8. The system according to claim 7, the data module is further configured for:
constructing a mapping relation between the nodes and attribute lists of the attribute information network, wherein each entity node corresponds to a series of attributes, indicating that the entity node has the attribute list; and constructing a relation tree on the basis of an actual attribute relation according to all attributes of the target domain.

9. The system according to claim 7, the algorithm module is configured for:
performing core decomposition on the attribute information network G to obtain a subgraph H′ with a largest k-core, the k-core indicating a community where all nodes have degrees greater than or equal to k, which comprises: calculating a degree of each node in the attribute information network, that is, a number of edges connected to each node; removing all nodes in the attribute information network with degrees less than a predetermined threshold k and edges connected thereto; and repeating the removing until there are no more nodes with a degree less than k, thereby obtaining a remaining network structure as the subgraph H′ with the largest k-core;
calculating scores of all the nodes in the subgraph according to an attribute relation, comprising: defining a relation tree T, wherein the relation tree T defines an inclusion relation between attributes, and a meaning of a parent node attribute comprises a meaning of a child node attribute; and pre-constructing a distance index between attributes through the relation tree T, that is, calculating a distance between any two attributes on the relation tree; and calculating a score between a node and a search node through the score definition, marking the score as a score of the node, and repeatedly calculating scores of all the nodes in the subgraph; and
after obtaining the scores of all the nodes, marking a node with a lowest score at current time, and deleting the node, in which case numbers of nodes and edges in the subgraph are n and m; if m−n<2*(k\hat{ }2−k)−1, which indicates that the subgraph does not contain the k-core, exiting the method for attribute community search after adding the node with the lowest score; otherwise, repeating to perform core decomposition and delete a node with the lowest score until the subgraph no longer contains the k-core, in which case a community is returned as a search result.

10. The system according to claim 9, the algorithm module is configured for:
defining the relation tree and pre-constructing the distance index between attributes; traversing each attribute w and using a breadth-first search algorithm to mark an attribute reached at each hop until all attributes of the relation tree are traversed; for an attribute w′ reached at h^{th} hop, storing an index <w, w′> as a distance h; and obtaining an attribute distance index after processing all the attributes of the relation tree in sequence;
after obtaining the attribute distance index, traversing nodes of an entire subgraph except the search node for calculating a score of a target node, wherein in response to increasing of the score, an attribute correlation between two nodes increases, and the score is calculated as follow:
$$Score = ( {\sum }_{i = 1}^{n 1} 0. {9}^{mindistance ( {a}_{i} , B )} + {\sum }_{j = 1}^{n 2} 0 . {9}^{mindistance ( {b}_{j} , A )} ) / ( n 1 + n 2 ) )$$
wherein n1 is a number of attributes of the search node, a₁, a₂, . . . , aₙ₁ are attributes of the search node, A is an attribute sequence of the search node, n2 is a number of attributes of the target node, b₁, b₂, . . . , bₙ₂ are attributes of the target node, and B is an attribute sequence of the target node; mindistance (aᵢ,B) is a minimum value among distances between an attribute aᵢ and all attributes of attribute sequence B, and mindistance (bⱼ,A) is a minimum value among distances between an attribute bⱼ and all attributes of attribute sequence A.
